(19) United States
(12) Patent Application Publication
(10) Pub. No.: US 2008/0143004 A1
(43) Pub. Date: Jun. 19, 2008

(54) Method and System for Molding Optical Components

(76) Inventors: Teun Petrus Adrianus De Wilt, Eindhoven (NL); Maarten Johan Mathijs Van Bree, Veldhoven (NL)

Correspondence Address: GORDON & JACOBSON, P.C., 60 LONG RIDGE ROAD, SUITE 407, STAMFORD, CT, 06902, US

(21) Appl. No.: 11/912,059

(22) PCT Filed: Apr. 12, 2006
(86) PCT No.: PCT/EP0606/061558

§ 371 Date: Oct. 19, 2007

(30) Foreign Application Priority Data
May 3, 2005 (EP) 05103670.5

(51) Int. Cl. B29D 11/00

(52) U.S. Cl. 264/2.3; 425/144; 425/87

(57) ABSTRACT

A method of and system for molding optical components uses a thermo-curable composition, which has unconventional low shrinkage and can be heated to high temperature so that it can be cured at unconventional fast rate with relative simple means. This allows fast production of optical components at low cost both in small quantities and in large quantities.

### FIELD OF THE INVENTION

The invention relates to a method of molding optical components, which method comprises the steps of:
providing a polymerizable component forming composition;
providing a mold assembly comprising at least one mold member having a molding surface profile, which corresponds to a required surface profile of the component to be formed;
loading a required amount of the composition in the mold assembly;
causing the composition to polymerize in the mold assembly so that it solidifies to a solid component having a shape corresponding to the profile of the at least one mold member, and
removing the solidified component from the mold assembly

The invention also relates to a system, which is suitable for performing this method.

### BACKGROUND OF THE INVENTION

Human-sight improving lenses, or ophthalmic lenses, such as eye-glass lenses and contact lenses have historically been made by machining a lens material, in button (or block form) on front and back surfaces thereof to produce an unfinished lens product having the required fit, or “base curve” and visual correction to compensate for one or more refractive abnormalities of the eye. Such refractive abnormalities may include myopia (nearsightedness), hypermetropia (farsightedness), astigmatism, presbyopia and the like. Using conventional machining technology, the optic faces of the unfinished lens require polishing in order to remove rings, known as “turning rings”, on the unfinished lens that have been created by the machining process.

Since the machining process is very labor-intensive it is preferred to manufacture lenses by molding plastic. Plastic has been chosen for its lightweight, density, refractive index and impact resistance. To form a lens, two mold members, often referred to as a front mold and a back mold in the art of lens making, are used, which together form a mold assembly. Each mold member has an inside, preferably polished, surface, which faces the other mold member. When these mold members are properly positioned at a desired distance and rotational orientation to each other, they define a mold cavity wherein the plastic can be loaded. The polished inside surfaces of the mold members, usually called molding surfaces, are mirror images of the main surfaces of the lens to be formed. A fluid lens-forming mixture, or composition, normally a liquid monomer, is loaded and contained in the cavity defined by the two mold members. Once the fluid lens-forming composition is in the cavity, it is cured to form a hardened polymeric lens taking the shape of the molds, whereby the main lens surfaces are replicas of the polished surfaces of the mold members.

Curing of the lens-forming composition, i.e. polymerizing the monomer composition can be performed by irradiating the composition with ultraviolet (UV) radiation, as described in, for example U.S. Pat. No. 6,790,022. The specification of this patent and of a number of related patents having the same filing date and the same assignee includes a very extensive description of a lens forming process and -system, using injection molding. The lens-forming composition used in the process of U.S. Pat. No. 6,790,022 comprises, in addition to a monomer, a co-initiator composition configured to activate curing of the monomer and a photo initiator configured to activate the co-initiator composition in response to being exposed to activating radiation. The lens-forming composition may also include other components such as UV radiation absorbers and photochromic compounds. Curing by means of UV radiation has the main advantage that it can be performed in a short time interval. However, it also presents some problems that must be overcome to produce a viable lens. Such problems include yellowing of the lens, cracking of the lens or mold members, optical distortion in the lens and premature release of the lens from the mold members. Due to the relative rapid nature of UV radiation initiated reactions, it is a challenge to provide a composition that is UV radiation curable to form an eyeglass lens. Excessive exothermic heat tends to cause defects in the cured lens. To avoid such defects, the level of photo initiator may be reduced to levels below what is customarily employed in the UV radiation curing art.

While reducing the level of photo initiator addresses some problems, it may also cause others, for example incomplete curing especially in regions near the edge of the lens. This may result in a lens having a “wet” edge covered by sticky uncured lens-forming composition. Furthermore, uncured lens-forming composition may migrate to and contaminate the optical surface of the lens upon de-molding.

To improve the curing, or polymerization, process it is proposed in U.S. Pat. No. 6,790,022 to combine UV radiation with heat. It is stated that by means of the combination of UV radiation and heat a lens can be formed within thirty minutes. In one embodiment, the lens-forming composition may be exposed to continuous activating UV radiation to initiate curing and subsequently the composition may be treated with additional activating radiation and heat to further cure the composition. In another embodiment, the lens-forming composition may be exposed in a heated curing chamber to initiate curing of the composition and subsequently the composition may be treated with additional activating radiation and heat to further cure the composition. The subsequent curing is carried out in an additional curing chamber so that a complex and large molding machine is needed.

A main problem that occurs typically when the lens-forming composition is rapidly heated during curing is shrinkage of the composition. In U.S. Pat. No. 6,790,022 it is proposed to solve this problem by configuring the composition such that it exhibits increased adhesion to the molds and reduces the incidence of premature release. The increased adhesion of the lens-forming composition may allow higher curing temperatures to be used. In the description of U.S. Pat. No. 6,790,022 it is furthermore believed that the specific lens-forming composition may exhibit less shrinkage, however a shrinkage value is not mentioned.

A well-known alternative for UV curing is thermo-curing, i.e. curing by heat. A thermo-curing process and apparatus is described in a number of documents, for example U.S. Pat. No. 4,840,754, which is concerned with molding products such as ophthalmic lenses comprised of thermo-curing materials including thermo-setting and thermo-plastic materials. After the moldable material such as polymethyl methacrylate, silicone rubber or hydrogel polymers has been supplied to the mold cavity between two mold members of the molding apparatus, at least one of the mold members is heated by electrical heaters so that the curing is accelerated and the curing time reduced. The curing temperature is, for example, 150° C. and the curing time is, for example about 15 minutes. The problem of shrinkage of the moldable material is not addressed.

The manufacture of ophthalmic lenses nowadays is an intricate and time consuming process, which requires dedicated large and expensive apparatus. Therefore such lenses are manufactured at a few specialized sites where a huge number of lenses are made to be shipped to so called Rx labs, which make the final, or finished, lens upon request of, for example optical, or optician, shops. These shops order specified lenses, whereby the specification is based on measurement of customer eyes, which measurement is performed by an oculist or the optician. Due to this complicated sequence, the customer receives the required eyeglass lens only after a few days at fastest.

### SUMMARY TO THE INVENTION

It is an object of the present invention to make a breakthrough in the technology of manufacturing ophthalmic lenses and other optical products and to provide a method of fast molding optical components, which method can be performed easily by simple means and at low costs. This method is characterized in that,
The step of providing a polymerizable composition comprises providing a thermo-curable composition comprising a two-component polyurethane system having a low shrinkage of the order of 4%;
the step of causing the composition to polymerize comprises heating the composition to a temperature higher than 110° C. during less than 30 minutes thereby solidifying the composition at a fast rate, and
the step of removing comprises cooling down the solidified component and releasing it from the at least one mold member.

The invention is based on the insight that it would be very attractive to decentralize the ophthalmic lens manufacture and makes an inventive and very effective use of recent developments in the art of lens-forming compositions. These developments have resulted in a new type of such a composition showing a unique combination of attractive properties. These properties are:
superior optical qualities similar to those of, for example diethylene bis allyl carbonate (ADC), which is a well-known hard resin lens material;
low viscosity;
very fast polymerization at high temperatures, and
a very low shrinkage.
   The combination of these properties allows for the design of a new and simple method of producing a lens or other optical component, which method can be carried out by means of relative simple and low-cost means and allows very fast molding of optical components such as an ophthalmic lens. The molding time, i.e. the rate of curing depends on the shape and dimensions of the component to be produced. For example, a thin, i.e. low power, lens may be cured in less than 5 minutes at a temperature of 130° C. For curing a thicker lens more time is needed.

Conventional component molding processes often use injection molding methods, whereby the required volume of polymerizable composition is forced through a nozzle into a closed mold assembly, which requires pressure equipment. On the contrary, in the new method casting is used, i.e. the polymerizable composition is introduced between the molding surfaces of a mold without significant molding pressure. This means that the molding apparatus can be simplified substantially.

A molding surface is understood to mean an interior, preferably polished, surface of a mold member, which should be brought into contact with the polymerizable composition and has a surface shape profile corresponding to a required surface profile of the molded component.

The new method can be performed at arbitrary locations such as in optical shops. It is now possible that an ophthalmic lens, which may be an eyeglass lens, a contact lens or in intra-ocular lens, i.e. a lens to be placed within the eye behind the cornea, is made in an optical shop immediately after a customer has delivered his lens receipt or after the optician has determined which lens he needs. The waiting time for the customer can be reduced substantially. Moreover, since sending of a lens receipt to a final lens manufacturer such as an Rx lab and transportation of a vulnerable finished lens is no longer needed; the cost of an ophthalmic lens can be reduced.

With the new method different types of ophthalmic lenses can be produced such as spheric single vision, aspheric single vision, flattop bifocal or progressive multifocal lenses. Moreover, with the new method also other types of optical components can be produced and the method can be used wherever a de-centralized production of such components is required or provides advantages.

The above mentioned total shrinkage comprises shrinkage caused by the transition of the monomers to the polymer and shrinkage, which occurs during curing of the polymer. The latter shrinkage is preferably lower than 1.5%.

Shrinkage of the composition is a serious problem that occurs especially when the composition is heated to a high temperature to accelerate curing of the composition. Classical curing processes using conventional polymerizable compositions, which comprise monomers in liquid form, are known to develop some flaws. The polymerization reaction results in severe volume shrinkage, which causes the component formed to delaminate from the molding surface, or the appearance of cracks or strains in the component formed. Moreover, the supplied heat results in severe yellowing of the component formed, which means that a clear component will become yellow.

The problem of shrinkage that occurs during curing of organic plastics, particularly exothermic plastics has been widely recognized and has been addressed in a number of documents. For example in U.S. Pat. No. 6,790,916 shrinkage equal to or lower than 3.5% is reported. However this patent is not concerned with polymerizable compositions showing good optical qualities, but with materials having, in addition to low shrinkage, good mechanical properties and still high elasticity at low temperatures. In documents, which are concerned with polymerizable compositions having good optical properties, such as PCT patent application WO 01/31584 a minimum shrinkage of about 10% is mentioned. Moreover, a polymerization time from one hour to hundred hours is reported.

Essential is that the new composition shows shrinkage, for example 4% or less, which is considerably lower than the shrinkage of conventional compositions having similar optical qualities. After the molded composition has cooled down at the end of the molding cycle it can easily be released.

It has been demonstrated that with a composition comprising a two-component polyurethane system good results can be obtained.

Additional components may be included in the composition to improve its polymerization and release from the mold member(s) and to protect the molded component against environmental influences.

Preferably, the method is further characterized in that the component-forming composition is heated to a temperature in the range of 130-160° C. during the curing step.

It has been shown that at such temperatures a polyurethane composition can be reacted to a cured polymer in a length of time of 30-120 seconds, depending on the volume of the composition, which is extremely short compared with reaction times of conventional compositions. It is the very small shrinkage of the used composition that allows the use of the high temperature.

With respect to the heating of the polymerizable composition several Embodiments of the method can be distinguished.

A first embodiment is characterized in that the component-forming composition is heated by means of electrical heating the molding surface of the at least one mold member.

It is remarked that electrical heating of mold inserts is known per se, for example from U.S. Pat. No. 5,261,806. This document describes a molding system wherein interchangeable mold inserts each having its own electrical heater bands and associated wiring are used, which allows easy switching from one production job to another. The heater bands are wrapped around the mold inserts. The polymerizable composition is loaded in the mold cavity by injection. No details are given about the type of products that are molded, the polymerizable composition that is used, the polymerization time and the shrinkage.

Preferably the first embodiment is characterized in that use is made of at least one mold member having the shape of a shell, which includes the molding surface and is provided with an electric resistive heating coating, which is connected to an electrical power source.

The first embodiment is more preferably characterized in that the heating coating is a film of Al₂O₃.

It is remarked that U.S. Pat. No. 5,569,474 discloses what, for an optimum heating effect, the value of the surface resistivity should be as a function of the surface dimensions, the maximum value of the allowable voltage, the maximum value of the allowable current and the input power. This document relates to a mold assembly comprising a stationary and a moving mold member, each of which is provided with a mold insert. The moving mold insert is provided with a thin film electric resistor, which is connected via connecting bolds to an electric power source to heat the molding surface of the mold insert. This mold assembly is intended to be used in an injection molding apparatus and the film resistor is made of one the materials TiN, TiC, TiCn, TiAlN and CrN. The advantage of an Al₂O₃ film heater used with the new method is that this film can be heated very fast to the required temperature.

A second embodiment of the method is characterized in that the component-forming composition is heated by means of a high frequency electromagnetic field.

Such an electromagnetic field, at a frequency at which the OH molecules of the composition react, for example a frequency between 10⁸ and 10¹⁰ Hz, can be generated by means of an electric coil arranged in the vicinity of the mold inserts. For example the mold assembly including the component forming composition can be placed in a microwave oven, also called a magnetron, which nowadays is a simple consumer apparatus.

The use of a microwave oven to heat a polymerizable composition in a process for manufacturing a contact lens is known from U.S. Pat. No. 4,879,072. However, in the process of this document first a lens pre-form is made of a protein biological material at a temperature between ambient temperature and the temperature at which the material liquefies. The preform is then placed in a mold and its material is liquefied by exposing it to the high frequency electromagnetic field so that it acquires the final lens shape. The material is then gelified by cooling it in the mold. After being removed from the mold, the material should be cross-linked by contact with a cross-linking agent such as an aldehyde.

A third embodiment of the method is characterized in that the component-forming composition is heated by immersing the mold members including the component-forming composition in a medium heated to a temperature at which the composition polymerizes very fast.

The medium may be oil that is heated to a temperature of, for example 130° C. Oil has been chosen because it can be heated to this high temperature. In conventional methods, the mold members are insulators and the component-forming composition, in the form of a liquefied monomer mixture, between the mold members is polymerized by immersing it in a volume of water heated to, for example 70° C. and then cooled down. Polymerization time is, for example of the order of 24 hours. The mold members used with the new method may be reduced to shells, which may be heat conducting and polymerization time may be reduced to less than one minute due to the high temperature. By retracting the mold shells including the polymerized composition from the oil, the composition cools immediately.

Preferably the above-described embodiments of the method may be further characterized in that use is made of at least one mold member having a molding surface, which shows the complete surface profile of the corresponding surface of the required component.

The complete surface profile is understood to mean the required surface profile for the finished lens or component. In case of a lens, this surface profile has in principle a spheric or aspheric shape on which a prismatic or cylindrical term may be superposed. A lens molded by means of such a mold member needs no further shaping steps such as grinding and polishing. Also the surface quality of the molding surface may be such that the required surface quality of the final lens is obtained by the molding process.

To reduce the number of mold assemblies or mold members, a user of the method, such as an optical shop, should keep in stock, the method is preferably used in combination with at least one adaptable mold member having an adaptable molding surface profile.

An adaptable molding surface profile is understood to mean a surface profile that can be adapted to the profile of the lens or component to be molded. The use of an adaptable mold in the manufacture of an eyeglass lens is known per se, for example from U.S. patent application 2003/0052425. The mold comprises a flexible membrane, which depth profile can be adjusted by means of varying a pressure exerted on the membrane by a fluid, for example a gas, that is in contact with the membrane. The profile of the membrane, thus that of the lens to be molded, can be controlled by projecting a standard image through the membrane and comparing the resulting image with a calibration image.

The new method may be further characterized by the additional step of providing the molded component with a hard coating.

The hard coating, which protects the lens or component for mechanical or other disturbances, may be an acrylic or silicon type hard coating. Such a coating may be supplied to the molded lens by means of methods ordinary employed, such as dipping methods, spinning methods and spraying methods. The dipping method and the spinning method are especially preferred in view of the smoothness of the coating formed.

The method may also be further characterized by the additional step of providing the molded component with an anti-reflective coating.

As known in the art, the anti-reflective coating may include a coating obtained by laminating a high refractive index layer and a low refractive index layer alternately. The high refractive index layer can most preferably be made of zirconium oxide. It can also be made of aluminium oxide, titanium oxide, cerium oxide, indium oxide, neodymium oxide or tantalum oxide. The low refractive index layer can most preferably be made of silicon oxide. It can also be made of magnesium fluoride. The lamination order of the layers can be an order of a high refractive index layer, a low refractive index layer etc, or reversed.

The polymerized lens obtained with the new method described above can be subjected to other treatments such as tinting.

The invention also relates to a system for molding optical components by means of the method as described herein before and comprising a mold assembly having two mold members, which are arranged to define a mold cavity for receiving a polymerizable component-forming composition, at least one of the molding members having a molding surface profile corresponding to a required surface profile of the component to be molded and means to accomplish polymerization of the composition. This system is characterized in that the mold assembly is arranged such that it can be filled with a thermo-polymerizable composition, comprising a two-component polyurethane system, without exerting force on the composition and in that the means to accomplish polymerization comprises heating means far heating the composition to a temperature higher than 110° C. during less than 30 minutes.

This system is unique in that it combines force less casting of the viscous component-forming composition with fast thermo-hardening, i.e. polymerizing by means of heat, of the composition. In conventional fast molding systems UV radiation is used for curing, or polymerizing the component-forming composition.

A first embodiment of the system is characterized in that the heating means are constituted by electrical heating means for heating the side of at least one mold member, which side faces the composition during the polymerization step.

A second embodiment of the system is characterized in that the heating means are constituted by means for creating a high frequency electromagnetic field.

Such heating means are known per se in the art of molding lenses, however their use in a cast molding system is novel.

The system may be further characterized in that the mold assembly comprises a gasket to hold the mold members and co-define the mold cavity A gasket is well-known element in the lens molding technology. It is understood to mean a spacing seal, for example made of plasticised polyvinyl chloride

With respect to their application, the embodiments of the system can be divided into two types.

A first type of system, which is intended for operation by hand, is characterized in that the heating means comprises a fluid container for containing a hot fluid and provided with fluid heating means, which container is configured to receive the mold assembly including the component-forming composition.

This type of system is very suitable for molding lenses and other optical components at a small scale, because it comprises very simple means and requires only low investment so that it can be used in an optical shop or at other places where a limited number of optical elements should be produced. After the component-forming composition has been cast in the mold assembly, this assembly is immersed in a simple container filled with a liquid heated to a temperature at which the composition cures immediately. Thereafter the mold assembly including the molded component can be cooled quickly, for example by means of cold water. Heating of the liquid in the container can be performed by various simple means, for example by means of a gas heating device or an electrical heating device. It is also possible to provide the wall of the container with an electric resist heating coating, for example of Al₂O₃, which is connected to an electrical power source.

A preferred embodiment of the first type of system is characterized in that the fluid is oil and in that the heating means are configured to heat the oil to a temperature of at least 120° C.

As already remarked at such temperatures the polymerization time of the composition may be of the order of minutes, depending on the volume of the composition, thus on the size of lens or other optical component to be formed.

A further preferred embodiment of the first type of system is, characterized in that at least one of the mold members has the shape of a shell, which includes the molding surface profile.

Using shells as mold members allows reducing the weight of the mold assembly and renders it easily manageable.

This embodiment may be further characterized in that the shell is provided with an electric resistive heating coating, which is connected to an electric power source.

In this way the component-forming composition within the shell(s) can easily be heated to the required temperature.

Preferably the latter embodiment is characterized in that the coating material is Al₂O₃.

This material can be heated to high temperatures within a very short time.

Although the main object of the invention is to provide a method and system for producing optical components at a small scale and with simple means, the features of the invention can also be used for large-scale production of such components. This results in a second type of system, which is characterized in that it is configured in the form of a cast-molding machine comprising a machine frame, the mold assembly being mounted in the frame such that the mold members are movable relative to each other and in that at least one of the mold members is provided with heating means.

An embodiment of this system is characterized in that at least one of the mold members is provided with cooling means.

Such means allow fast cooling of the molded component.

Another embodiment of this system is characterized in that at least one of the mold members comprises a member base and a mold insert, the heating means being arranged in the mold insert.

### BRIEF DESCRIPTION OF THE DRAWING

These and other aspects of the invention will be apparent from and elucidated by way of non-limitative example with reference to the embodiments described hereinafter. In the drawings;

FIG. 1 shows a conventional mold assembly;

FIG. 2 shows a first embodiment of the mold assembly for use in the molding system according to the invention;

FIG. 3 shows a second embodiment of the mold assembly for use in the molding system according to the invention;

FIG. 4 shows a third embodiment of the mold assembly for use in the molding system according to the invention;

FIG. 5 shows a mold member provided with heating means;

FIG. 6 shows a molding apparatus for use in the molding system according to the invention;

FIG. 7 shows a temperature versus time curve of a component-forming composition;

FIG. 8 shows a mold member provided with cooling means;

FIG. 9 shows molding on a preform, and

FIG. 10 shows an apparatus for simultaneously molding and coating a component.

In these figures equivalent elements are denoted by the same reference numerals.

### DETAILED DESCRIPTION OF PREFERRED EMBODIMENTS

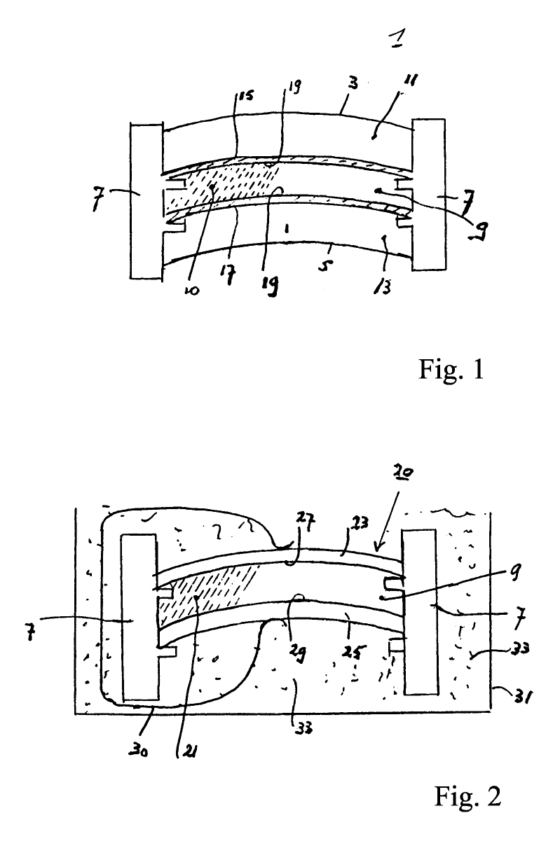

FIG. 1 shows a vertical cross-section of a conventional mold assembly 1 comprising a first mold member 3 and a second mold member 5. The mold members are retained by a gasket 7, which, together with the mold members 3 and 5, defines a mold cavity 9 for receiving a polymerizable component forming composition 10, of which only a half volume is shown in FIG. 1. The gasket 7 may be made of rubber or plasticed polyvinyl chloride. The mold members 3 and 5 comprise a member base 11 and 13, respectively, which may be made of glass such as glass of the type BK7. The inner side 15 and 17 of the mold members 3 and 5, respectively form molding surfaces and their surface profile is the mirror image of the corresponding surface of the component to be formed, in this embodiment a lens. Preferably, the inner sides of the mold members are metallised; i.e. coated with a layer 19 of, for example nickel (Ni), chromium (Cr) or silver (Ag). Such a layer prevents composition material from sticking to the mold member when the molded lens is removed from the mold assembly and allows repetitive use of the mold member without intermittently cleaning.

The required surface profile at the inner side of the mold members may be obtained by machining, for example by grinding and/or polishing the inner surfaces of the bases of the mold members according to the specification of the lens to be formed. Since the metal layer 19 coated on the inner surface is thin, it shows the required surface profile. It is also possible to use a standard mold member base and to use for different mold inserts to produce lenses with different specifications. A mold insert, which is frequently used in the manufacture of plastic lenses, consists of a plate, one surface of which is adapted to the inner surface of a mold member base, whilst the opposite surface shows a profile that is the mirror image of the required lens surface profile.

By using the recently developed type of lens-forming composition and optimizing the curing temperature and -time a new and dramatically improved lens molding process is obtained. Since this composition shows a very low shrinkage, the above-mentioned problems, which are inherent to shrinkage, are avoided. Moreover, the molded lens shows excellent optical quality and is scratch and impact resistant.

FIG. 2 shows a vertical cross-section of a first embodiment of a mold assembly that is especially suitable for use with the new molding method. This mold assembly 20 differs from that of FIG. 1 in that shells 23 and 25 have replaced the massive mold members 3 and 5, respectively, whereby the inner surface 27 and 29, respectively of the shells constitute the molding surfaces. Such shells provide the great advantage that they allow heating of the composition to the required temperature much faster than is possible with the mold assembly of FIG. 1. The shells may be made of, for example nickel chromium and they may be contained in a gasket 7. The metal shells may be manufactured by first producing a glass master (mother mold) having the required surface profile and then replicating this profile in a final metal shell by means of well-known processes of sputtering and/or electroforming, possible via intermediate steps of forming sons etc.

For producing a lens, the mold cavity is filled with the recently developed type of polymerizable lens-forming composition 21, simply by casting this composition in the cavity. The composition, usually comprising two main components as will be described hereinafter, should have a sufficient low viscosity at a temperature of, for example 25-50° C. By casting the composition at such a temperature in the mold cavity, it is ensured that this cavity will be filled throughoutly and the inner shape of the mold cavity will determine the shape of the final lens. After the composition has been loaded in the mold cavity, polymerization and curing starts.

According to the invention, the curing is substantially accelerated thermally whereby use is made of the fact that the component-forming composition used shows a very low shrinkage and can be heated to high temperatures. For example, if the composition is heated to a temperature of 130° C. or higher the polymerization time may be reduced to the order of minutes. After the polymerization has been completed, the composition, i.e. the molded lens is cooled down and subsequently the mold assembly is opened and the molded lens is taken out. Enforced cooling of the molded lens can be realized by immersing the mold assembly in a tank with cold water. After cooling down of the molded lens the mold assembly can be opened and the lens be loosed by a simple pat on the assembly. Cooling down of the composition causes a very low shrinkage, which does not affect the shape of the molded lens, but is sufficient to warrant easy loosening of the lens from the shells.

In this way a very effective use is made of the properties of the new type of lens-forming composition to arrive at a new type of lens molding process. This process distinguishes from conventional processes in that it is very fast and can be carried out with simple means so that it can be easily used at a large number of non-specialized sites. The new composition can be easily cast without force, shows very low shrinkage, can be fast heated to high temperatures, shows superior optical qualities and can withstand mechanical forces. In case the new lens-forming composition is processed in the conventional way, i.e. with conventional curing temperature and -time, some of said properties are available.

During the polymerization cycle the shells can be fixed, for example by means of a spring 30, which exerts an appropriate force on the shells.

For fast heating of the lens-forming composition to the required temperature several methods can be used. A first method is immersing the shells 23 and 25 including the liquefied composition in a tank 31 filled with oil 33 at a temperature of, for example 130° C., as schematically shown in FIG. 2.

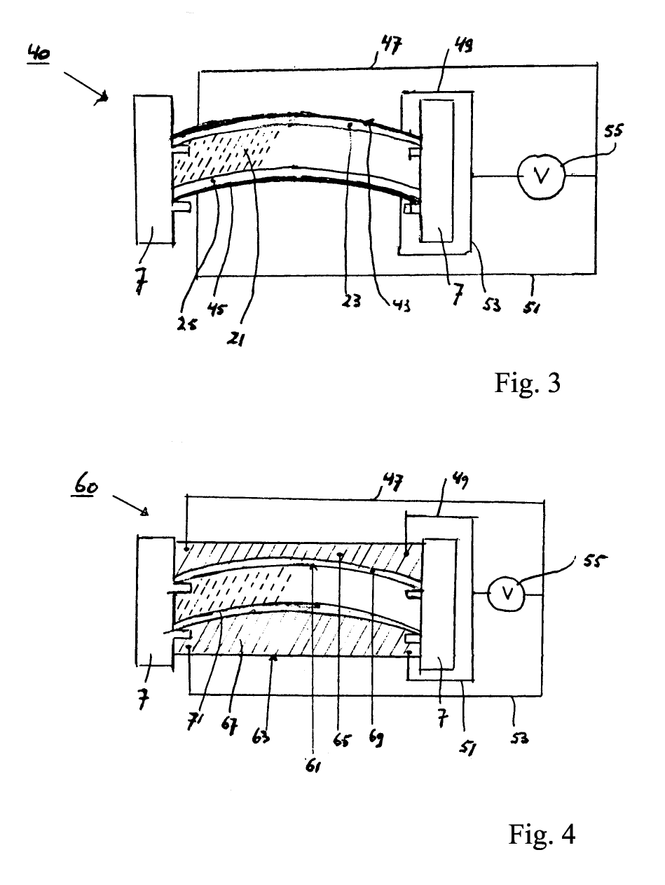

FIG. 3 shows schematically a second method of fast heating the composition. The shells 23 and 25 of mold assembly 40 are provided with electrically resistive layers 43 and 45, which are connected by wiring 47, 49, 51 and 53 to an electrical power source 55. If the power source is switched on, the layers are heated very fast to the required temperature. They material of the layers is, for example Al₂O₃. This material has been proven to be very suitable for fast heating of an object with which it is in contact. This material is nowadays used in a heating element of an electrical water cooker. With respect to the requirement for the surface resistivity of the layer, reference is made to U.S. Pat. No. 5,569,474. This document discloses what, for an optimum heating effect, the value of the surface resistivity should be as a function of the surface dimensions, the maximum value of the allowable voltage, the maximum value of the allowable current and the input power. U.S. Pat. No. 5,569,474 relates to an injecting molding apparatus and not to a casting molding apparatus.

FIG. 4 schematically shows another embodiment of a mold assembly 60, which is suitable for use with the new molding method. This assembly comprises two mold members 61 and 63, each having a member base 65 and 67, respectively of an electrically conductive material such as aluminium or copper. The inner sides of the member bases are coated with a layer 69 and 71, respectively of, for example nickel, chromium or silver or another material, which prevents that composition material sticks to the mold member. The mold members 61, 63 and the polymerizable composition 21 between these members are heated to the required temperature, for example 110 to 130° C. by connecting these members via wiring 49, 51, 53, 55 to an electrical power source 59, similar as in the embodiment of FIG. 3.

During the polymerization cycle the mold members can be fixed by means of a spring, in a way similar as shown in FIG. 2. It is also possible to tighten the mold members in the gasket.

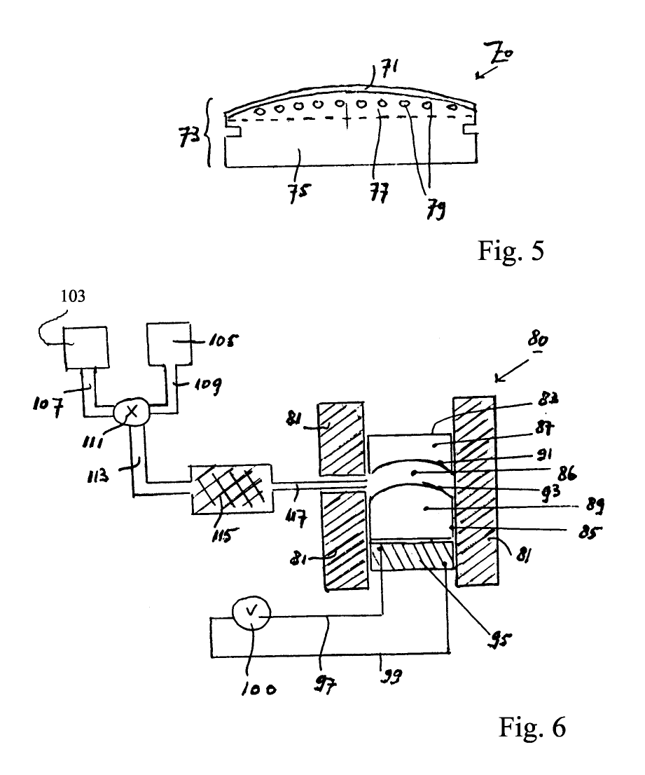

FIG. 5 shows another type of mold member that is preferably used in the embodiment of FIG. 4. The base 73 of this mold member 70 comprises a thicker heat-insulating portion 75, which provides rigidness to the mold member, and a thin portion 77. The latter portion is provided with heating wires or -bands, denoted by the small circles 79, to be connected to an electric power source, similar as shown in FIG. 4. Since only the portion 77 and the layer 71 need to be heated, heating of the lens-forming composition can be performed faster and in a more efficient way as with the mold members shown in FIG. 4.

Heating of the lens-forming composition within the mold cavity can also be performed by means of high frequency (HF) electromagnetic waves. In principle, such waves can be generated by an electrical coil, which is placed in the neighborhood of the mold assembly. A more practical and low-cost alternative is to place, for curing the composition, the mold assembly in a microwave oven, which is a household appliance of frequent occurrence.

In the embodiments of FIGS. 2-4 the molding surfaces are concave and convex respectively so that the molded lens is a convex/concave lens, which is the most usual type for an ophthalmic lens. Other types of lenses, such as bi-convex bi-concave, plano-convex and plano-concave lenses may also be produced if corresponding types of mold members are used. It will be clear that also optical component such as prisms or gratings may be produced. For producing a grating at least one of the molding surfaces should be a ruled surface.

In a non-limiting example, a mold cavity as described herein before was filled with a low shrinkage two-component polyurethane mixture. This mixture may be a two-component polyurethane system as obtained from Great Lakes Chemical Corporation with code name DP143108. The first component A of DP143108 consists of a poly alcohol with a viscosity of 1.5 Pa·s and the second component B consists of an isocyanate functional pre-polymer with a viscosity of roughly 1 Pa·s. The two components A and B were thoroughly mixed in a pre-set ratio of 1:1.6 through a mixer into the mold cavity. Prior to mixing, the two components A and B were degassed and filtered over a 1 micron filter. The temperature of the components A and B during mixing was maintained at 50° C. After the mold cavity was filled with the mixture, the latter was heated to 130° C. and the polyurethane was reacted to the polymer and cured in 4 minutes. The mold cavity was cooled down, opened and the molded article was taken out.

The following table shows the physical properties of this article or component. This component shows good optical characteristics, like transmission, Abbe value and color in comparison with a component made of RAV 7AT (diethylene bis allylcarbonate). The latter material, obtained from Great Lakes Chemical Corporation is the conventional standard material for producing plastic ophthalmic lenses. This material was cured with 27% Perkadox IPP-NS10 from Akzo Nobel using a standard thermal cure in glass molds of 21 hours with increasing temperature from 45° C. to 80° C.

| Property | Unit | Example | RAV 7AT |
|---|---|---|---|
| hardness | Rockwell | 95 | 99 |
| Transmission | % | 91 | 92 |
| Yellowness index (4 mm) | YI | 0.2 | 0.9 |
| Abbe value | — | 53 | 58 |
| Index | N^{d}₂₀ | 1.503 | 1.501 |
| Total shrinkage during cure | Volume % | 1.5% | 12.4% |

The mold assemblies of FIGS. 2-5 are simple and lightweight and thus easy to handle. These assemblies can be used for molding components by hand, in case a limited number of components have to be produced. The new molding method can also be used with a molding apparatus for mass molding optical components.

FIG. 6 shows schematically an embodiment of such an apparatus in a vertical cross-section. The apparatus comprises a main frame 81, for example made of steel for receiving two mold members 83 and 85, which define a mold cavity 86. The mold members comprise a member base 87 and 89, respectively, for example made of an alloy of beryllium and copper or of aluminium. The inner sides of the member bases are coated with a layer 91 and 93, respectively of, for example nickel or chromium to warrant easy release of the molded component and avoid sticking of composition to the mold members. The apparatus further comprises a heating element 95 of electrically resistive material, which is connected via wires 97 and 99 to an electrical power source 100. If this power source is switched on, the polymerizable composition within the mold cavity will be heated in short time to the required temperature by the heating element 95 via the mold member 89. The time for heating can be further decreased by arranging a second heating element (not shown in FIG. 6) at the side of the mold member 83.

For heating the mold cavity use can be made also of a number of heating elements included in the base of the mold member(s).

Instead of with an electrical heating element, such as element 95 in FIG. 6, the apparatus may be provided with an electrical coil in the neighborhood of the mold cavity to generate high frequency waves by means of which the composition within the cavity can be heated. It is also possible to use the induction principle to heat the component forming composition in the mold cavity.

The left-hand part of FIG. 6 schematically shows how the component-forming composition is supplied to the mold cavity 86. The constituents of the composition, herein above called components A and B, are received separately by the optical component manufacturer; this is indicated in the FIG. 6 by two reservoirs 103 and 105, which contain component A and component B, respectively. Via conduits 107 and 109 the components are supplied to a tap 111, which if opened combines the two components. The combined components are supplied via a conduit 113 to a mixer 115, which mixes the components thoroughly so that the required composition is obtained. This composition is supplied via conduit 117 in the mold cavity 86. A similar configuration can be used to fill the mold cavity of the molds shown in FIGS. 2-6 for manually molding process.

The new type of composition described herein above shows a low viscosity and, preferably, is mixed and supplied to the mold cavity at a temperature in the range of 50° C. to 60° C. This allows an optimum filling of the mold cavity without using pressure. For molding a component no high pressure is needed. Moreover, since the component-forming composition shows very low shrinkage, the shrinkage compensation, which is needed to prevent prematurely loosing of the component from the mold insert(s) is very small and can be realized by very simple means. As a result, the apparatus, which is used in combination with the new type of component-forming composition to perform the new molding method, is unique and considerably less complex than a conventional molding apparatus, be it a thermo-molding apparatus or an UV molding apparatus.

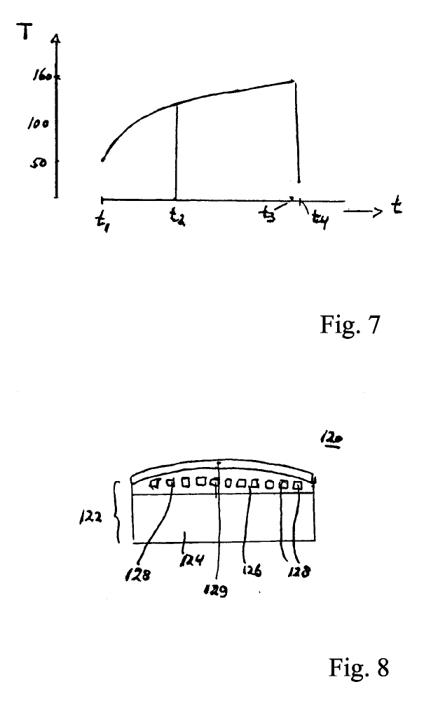

FIG. 7 shows the heating curve of the new type of component-forming composition, i.e. the variation if its temperature T as a function of time t during a heating cycle. At moment t₁ the mold cavity has been filled with the composition, which has a temperature, for example in the order of 50° C. At moment t₃ the temperature of the composition has reached the required value of, for example of the order of 160° C. The process may be designed such that at moment t₁ there is a tolerance, or free space between the composition and the walls of the mold cavity of, for example 1-3 μm. If further at moment t₂ the tolerance is zero, it will be, for example, 5 μm at moment t₄, when the component has cooled down. This means that the component formed is free from the cavity walls and can easily be taken out. Such a design may also be used in the manual molding process using the mold assemblies shown in FIGS. 2-5.

Another aspect of the molding apparatus is that a very effective use can be made of the fact that the apparatus frame and the mold members are made of different materials. The coefficient of expansion of these materials, for example steel for the frame and beryllium/copper for the mold members, may be chosen such that during heating the mold members are clamped by the frame, whilst during cooling down the mold members are freed from the frame. In this way the mold members can be fixed in the required positions without using additional fixing means.

This idea is generally useable in the field of molding components. If, under certain circumstances there is no need for such a clamp, the inner walls of the frame may be coated with a heat-insulating material such as Teflon™.

Since the new type of composition can be heated in a very short time, in the order of minutes, to high temperatures, in the range of 110° C. to 160° C., the polymerization and curing of a component can be realized in a very short time interval so that the throughput of the apparatus is very high. Throughput is understood to mean the number of components that can be produced in a time unit.

To accelerate cooling down of the component-forming composition after a component has been formed, the apparatus may be provided with enforced-cooling means. Such means may be incorporated in a mold member as shown in FIG. 8. The base 122 of the mold member 120 comprises a lower, thicker, portion 124, which provides rigidity to the mold member, and an upper portion 124. The lower portion 124 may be made of an electrically insulating material. The upper portion 126 is provided with conduits 128 through which a cooling medium, such as cold water, can be guided or pressed, immediately after the composition within the mold cavity has polymerized and cured. In the embodiment of FIG. 8 the mold member comprises a thin insert 128 on top of the divide base member. It is also possible to use a thicker insert and to arrange conduits for the cooling medium in this insert. Then a single member base can be used.

Cooling down of the molded component can also be performed by means of enforced air cooling, for example by a ventilator. This type of cooling may also be used in the manual molding process using the mold assemblies shown in FIGS. 2-5.

The apparatus of FIG. 6 is shown only as an example of a thermo molding apparatus. For the person skilled in the art it will be clear that such an apparatus may be modified in many ways and that a number of alternatives can be used for the different apparatus parts.

The new method of molding allows molding of end products, i.e. products, such as lenses or optical components, which have their final shape, surface profile and surface quality. Due to the low viscosity of the component-forming composition during casting into the mold cavity, the composition exactly follows the surface profiles of the mold members. If the mold members surfaces have end-profile and end-quality, molded component will also have such a profile and quality, due to a/o the very low shrinkage of the composition.

The new method of molding can be made even more attractive if adaptable mold members or mold inserts are used. The profile of the molding surface, i.e. its curvature or the shape and dimension of a cylindrical or prismatic term if needed, of such a mold can be adapted to a required profile of a surface of the component to be molded. This allows reducing the number of mold members or mold inserts the user of the method and apparatus should keep in stock to be able to produce a variety of components. Developments on adaptable molds are going on and look promising.

For example, the adaptable mold disclosed in U.S. patent application 2003/0052425 can be used with the new molding method. This mold comprises a flexible membrane, which depth profile can be adjusted by means of varying a pressure exerted on the membrane by a fluid, for example a gas, that is in contact with the membrane. The profile of the membrane, thus that of the lens to be molded, can be controlled by projecting a standard image through the membrane and comparing the resulting image with a calibration image.

The present molding process can not only be used for producing complete components, but also for molding layers on a so-called preform or blank. A preform is understood to mean an intermediate component, which already has a base shape, which shape, on the one hand, approaches as far as possible the shape of the end component and, on the other hand is common to a number of different end components. The intermediate components may be manufactured in mass and at low costs, for example of glass, by techniques other than molding. The end surface profile and quality of the required component is obtained by molding a relative thin layer on the intermediate component. The refractive index of the molded (plastic) layer will usually differ from that of intermediate component, but this will have a negligible effect on the optical quality of the end component, because the thickness of layer is considerably smaller than that of the end component. Since molding a layer on a preform means that considerable less mass of composition has to be polymerized, such a molding requires even less polymerization time than molding a complete component.

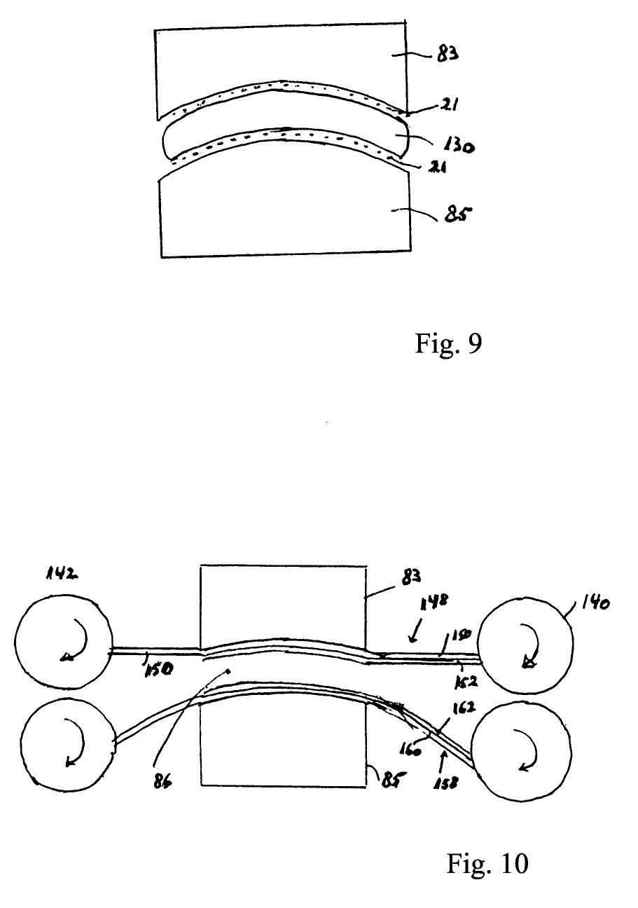

FIG. 9 shows two mold members 83 and 85 between which a preform 130 is arranged. The spaces between the preform and the mold member has been filled with the polymerizable composition 21 so that polymerization can start. After polymerization has been finished, the layers 21 have become part of the component 130, which has become an end component. The outer surface profile of the layers and thus of the end component correspond to the inner profiles of the mold members.

If required a component molded by means of the new method may be colored. It may also be provided with a hard coating to make it scratch and wear resistant and/or with an anti-reflective coating. In case the component comprises the two coatings, the hard coating is provided firstly. For the coloring and coatings conventional techniques may be used.

Especially in case an molding apparatus, such as that shown in FIG. 6 is used, the said coating(s) can be furnished in the form of a film, which is present between the mold members during the polymerization cycle, which film will be fixed to the molded component. This method of coating during polymerization, which is known per se from DE Patent Application 198 58 849, can be optimized for the present molding method as schematically shown in FIG. 10. Like the apparatus of FIG. 6, the apparatus shown in FIG. 10 comprises a first mold member 83 and a second mold member 85. In addition thereto, the apparatus of FIG. 10 comprises a first unwind spool 140 and a first wind up spool 142 to transport a film 148 across the mold cavity 86 defined by the mold members 83 and 85 via openings in the frame (not shown in this Figure). The film 148 comprises a film base 150 and a layer 152. During a polymerization cycle the component-forming composition presses the portion of the film at the location of the mold member 83 against the molding surface of this mold member 83 so that it follows the profile of the molding surface. After polymerization of the composition this portion of the layer 152 is fixed to one side of the molded component and removed from the film base. After the component has been removed from the mold assembly, the film is transported, by means of the spools 140 and 142, such that a subsequent portion of the film is located at the position of the mold member 83. The layer 152 on the film base may be a single layer: a hard coat layer or an anti-reflective layer. The layer 152 may also be a double layer consisting of a hard coat sub-layer and an anti-reflective sub-layer.

The apparatus may comprise a second unwind spool 154 and a second wind up spool 156 to transport a second film 158 having a film base 160 and a layer 162, along the second mold member 85 so that a second side of the component can be provided with a hard coating and/or anti-reflective coating.

In this way the total production time of a component can be further reduced.

1. A method of molding optical components, which method comprises the steps of:
providing a polymerizable component forming composition;
providing a mold assembly comprising at least one mold member having a molding surface profile, which corresponds to a required surface profile of the component to be formed;
loading a required amount of the composition in the mold assembly;
causing the composition to polymerize in the mold assembly so that it solidifies to a solid component having a shape corresponding to the profile of the at least one mold member, and
removing the solidified component from the mold assembly, characterized in that:
the step of providing a polymerizable composition comprises providing a thermo-curable composition comprising a two-component polyurethane system having a low shrinkage of the order of 4%;
the step of causing the composition to polymerize comprises heating the composition to a temperature higher than 110° C. during less than 30 minutes thereby solidifying the composition at a fast rate; and
the step of removing comprises cooling down the solidified component and releasing it from the at least one mold member.

2. (canceled)

3. A method as claimed in claim 1, characterized in that the component-forming composition is heated by means of electrical heating the molding surface of the at least one mold member.

4. A method as claimed in claim 3, characterized in that use is made of at least one mold member having the shape of a shell, which includes the molding surface and is provided with an electric resistive heating coating, which is connected to an electrical power source.

5. A method as claimed in claim 4, characterized in that the heating coating is a film of Al2O3.

6. A method as claimed in claim 1, characterized in that the component-forming composition is heated by means of a high frequency electromagnetic field.

7. A method as claimed in claim 1, characterized in that the component-forming composition is heated by immersing the mold members including the component-forming composition in medium heated to a temperature at which the composition polymerizes very fast.

8. A method as claimed in claim 1, characterized in that use is made of at least one mold member having a molding surface, which shows the complete surface profile of the corresponding surface of the required component.

9. (canceled)

10. A method as claimed in claim 1, characterized by the additional step of providing the molded component with a hard coating.

11. A method as claimed in claim 1, characterized by the additional step of providing the molded component with an anti-reflective coating.

12. A system for molding optical components and comprising a mold assembly having two mold members, which are arranged to define a mold cavity for receiving a polymerizable component-forming composition, at least one of the molding members having a molding surface profile corresponding to a required surface profile of the component to be molded and means to accomplish polymerization of the composition, characterized in that the mold assembly is arranged such that it can be filled with a thermo-polymerizable composition, comprising a two-component polyurethane system, without exerting force on the composition and in that the means to accomplish polymerization comprises heating means far heating the composition to a temperature higher than 110° C. during less than 30 minutes.

13. A system as claimed in claim 12, characterized in that the heating means are constituted by electrical heating means for heating the side of at least one mold member, which side faces the composition during the polymerization step.

14. A system as claimed in claim 13, characterized in that the heating means are constituted by means for creating a high frequency electromagnetic field.

15. A system as claimed in claim 12, characterized in that the mold assembly comprises a gasket to hold the mold members and co-define the mold cavity.

16. A system as claimed in claim 12, for operation by hand, characterized in that the heating means are constituted by a fluid container for containing a fluid and provided with fluid heating means, which container is configured to receive the mold assembly including the component-forming composition.

17. (canceled)

18. A system as claimed in claim 12, characterized in that at least one of the mold members has the shape of a shell, which includes the molding surface profile.

19. A system as claimed in claim 18, characterized in that the shell is provided with an electric resistive heating coating, which is connected to an electric power source.

20. (canceled)

21. A system as claimed in claim 12, for mass production of optical components characterized in that it is configured in the form of a cast-molding machine comprising a machine frame, the mold assembly being mounted in the frame such that the mold members are movable relative to each other and in that at least one of the mold members is provided with heating means.

22. A system as claimed in claim 21, characterized in that at least one of the mold members is provided with cooling means.

23. A system as claimed in claim 21, characterized in that at least one of the mold members comprises a member base and a mold insert, the heating means being arranged in the mold insert.
